(19) United States
(12) Patent Application Publication
(10) Pub. No.: US 2024/0372858 A1
(43) Pub. Date: Nov. 7, 2024

(54) Digital Picture Verification for Communication Applications

(71) Applicant: T-Mobile Innovations LLC, Overland Park, KS (US)

(72) Inventors: Mark BALES, Lee’s Summit, MO (US); Zhisheng CHEN, Overland Park, KS (US)

(21) Appl. No.: 18/311,128

(22) Filed: May 2, 2023

(51) Int. Cl. H04L 9/40; H04L 9/32; H04W 12/42

(52) U.S. Cl. CPC H04L 63/0876; H04L 9/3236; H04L 63/101; H04W 12/42

(57) ABSTRACT

A system comprises a communication device and an VS server. The communication device is configured to receive, a communication message comprising a digital identifier (ID) from a source communication device; send a verification request for receiving an authentication result of the digital ID, wherein the verification request includes the digital ID; and display a visual identifier in response to receiving the authentication result. The VS server is coupled to the communication device and configured to receive, from a source communication device, first registration information of a sender, wherein the sender is associated with the source communication device; receive, from the communication device, the verification request that instructs the VS server to authenticate the communication message, wherein the communication message includes the digital ID; determine an authentication result based on the first registration information and the digital ID; and send, to the communication device, the authentication result.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Communication devices such as, for example, consumer devices and Machine-to-Machine (M2M) communication devices are widely deployed in a wireless network, such as a cellular network. Mobile devices may include a smart phone, a tablet computer, a wearable computer, or a desktop computer, while M2M devices may include Internet of Things (IoT) devices such as a thermostat, a refrigerator, a water meter, or other similar everyday IoT devices. Communication devices may access any number of cellular and Internet Protocol (IP) networks for receiving text data, voice data, video data, support services, and other similar services. Cellular networks may exchange wireless signals with mobile communication devices using wireless network protocols. Exemplary wireless network protocols include Institute of Electrical and Electronic Engineers (IEEE) 802.11 (WIFI), Long Term Evolution (LTE), fifth generation (5G) new radio (5GNR), and Low-Power Wide Area Network (LP-WAN).

Many aspects of a user's daily activities are tied to interacting with digital systems on a mobile device for communicating information and/or data from the mobile device over the Internet or a wireless network. For instance, users may use one or more digital systems of the mobile device to transmit and receive electronic mail, voice data, text messages, picture/image data, financial information, or other similar communication over the Internet. In some examples, an email or a social network message may include an identifier/identification of the sender in the communication to a user. However, the source/sender of the communication may not match the identifier presented in the communication that is received by the user.

### SUMMARY

In an embodiment, a system comprises a source communication device, a receiver communication device, and a verification system (VS) server. The source communication device is configured to send, to a receiver communication device, a communication message comprising a digital ID of a sending user associated with the source communication device; and send, to a verification system (VS) server, a communication log corresponding to the communication message and the digital ID. The receiver communication device is configured to receive a second communication message comprising a received digital ID; send, to the VS server, a verification request responsive to receiving the second communication message, wherein the verification request includes the received digital ID and metadata of the second communication message; receive, from the VS server, an authentication result responsive to sending the verification request; and display a visual identifier corresponding to the authentication result. The VS server is configured to receive, from the receiver communication device, the verification request for instructing the VS server to authenticate the received digital ID and the metadata; determine an authentication result based on the verification request, wherein the authentication result indicates whether the second communication message is same as the communication message; and send, to the receiver communication device, the authentication result.

In another embodiment, a method for digital picture verification is disclosed. The method comprises sending, by a source communication device to a receiver communication device, a communication message comprising a digital ID of a sending user associated with the source communication device; and sending, by the source communication device to a verification system (VS) server, a communication log corresponding to the communication message and the digital ID. The method further includes receiving, by the receiver communication device, a second communication message comprising a received digital ID; sending, by the receiver communication device to the VS server, a verification request responsive to receiving the second communication message, wherein the verification request includes the received digital ID and metadata of the second communication message; receiving, by the receiver communication device from the VS server, an authentication result responsive to sending the verification request, wherein the authentication result indicates whether the second communication message is same as the communication message; and displaying, by the receiver communication device, a visual identifier representing the authentication result.

In yet another embodiment, a verification system, (VS) server is disclosed. The VS server comprises a central processing unit (CPU); and a non-transitory memory comprising executable instructions that when executed by the CPU, causes the VS server to receive, from a source communication device, first registration information comprising digital identification (ID) of a sending user, wherein the sending user is associated with the source communication device; receive, from the source communication device, a communication log corresponding to a first communication message, wherein the communication log comprises first metadata; receive, from a receiver communication device, a verification request, wherein the verification request includes a second digital ID and second metadata of a second communication message, and wherein the verification request instructs the VS server to authenticate the second communication message; and send, to the receiver communication device, an authentication result responsive to receiving the verification request, wherein the authentication result indicates whether the second communication message is same as the first communication message, and wherein the authentication result enables the receiver communication device to display a visual identifier representing he authentication result.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a communication system according to an embodiment of the disclosure.

FIG. 2 is a flow chart of a method according to an embodiment of the disclosure.

FIG. 3 is an illustration of a communication device according to an embodiment of the disclosure.

FIG. 4 is a block diagram of a hardware architecture of a communication device according to an embodiment of the disclosure.

FIG. 5 is a block diagram of a communication system according to an embodiment of the disclosure.

FIG. 6 is a block diagram of a core network of a communication system according to an embodiment of the disclosure.

FIG. 7 is a block diagram of software architecture of a communication device according to an embodiment of the disclosure.

FIG. 8 is a block diagram of another software architecture of a communication device according to an embodiment of the disclosure.

FIG. 9 is a block diagram of a computer system according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

A communication device and other end-point devices (hereinafter referred to as “communication device”) are widely deployed in cellular networks. The communication device may exchange wireless signals with cellular networks using wireless network protocols. In a cellular network for example, in a 5G cellular network, a base station can include a radio access network (RAN) node such as, for example, a 5G evolved or enhanced gigabit Node B (gNB). These RANs use a radio access technology (RAT) to communicate between the RAN Node and the communication device (or UE).

Further, a user may interact with a variety of digital systems on a communication device to transmit and receive electronic communication such as electronic mail messages (email message), voice data, short message service (SMS) data and other text data and messages, video and/or image data, and other similar communications over the Internet. In examples, a communication device of a user may send and receive communication messages such as, for example, an email message, a social network message, or a message with an embedded address link to an online video conference or to an online phone conference. The communication message may include information that indicates the sender of the communication message, and may include a graphical text, a graphical photograph/image, or a graphical logo that identifies the source of the communication message. However, a malicious actor/attacker may spoof the communication message whereby the attacker may send a spam and/or phishing message containing forged information such as, for example, an electronic mail message with a fake address of a source of the electronic mail or an identification picture that is not a true identity of the source of the electronic mail. The spoofing message may be used by the attacker to trick a recipient of the spoofing message into thinking that the message came from a person or entity they either know or can trust. The source/sender of the message, who is the attacker, may not match the identification information attached to the communication that is sent to the recipient. Spoofing attacks may be prevalently used to covertly obtain sensitive and/or confidential information of recipients of these spoofed messages when the recipient unwittingly opens the message. As spoofing attacks have become more sophisticated, users are finding it difficult to trust the authenticity of the source of any received communication message. Users have used conventional digital picture identification verification methods that use facial recognition computations of a real-time picture of a source in order to validate the user of a received message. However, these facial recognition computations impart delays in sending and receiving communication messages between users.

As disclosed herein, a communication device of a user in the present application may interact with a digital identification (ID) verification service of a verifications system (VS) server in order to verify the authenticity of a source of the communication message. The communication application may be, for example, an email application, a social network application, an online videoconference application, or an online audio application, or similar types of application. In an embodiment, the communication devices of the source and the recipient may be a consumer device such as, for example, a smart phone, a tablet computer, a wearable computer, or portable and desktop computers, or an M2M device such as, for example, a thermostat, refrigerator, water meter, and other everyday devices. In an example, the communication device may include a communication application with an embedded OTT application (for example, an add-on or utility application) that receives a communication message from a source communication device and automatically sends (e.g., without additional user intervention) a verification request to the VS server to authenticate the source of the communication message. In an embodiment, the digital ID verification service may verify a digital ID of a sender user (or “source”) of a communication message in order to authenticate the true identity of the sender user of a communication message when the communication message is received at a receiver user (or “recipient”) communication device. In an embodiment, the OTT application is configured to send a communication log related to the communication message to a digital ID verification service of the VS server. In examples, the digital ID verification service is a cloud-based verification service of a mobile carrier that is configured to verify the authenticity of a source of the communication message when received by the recipient communication device in order to determine whether the communication message is a spoofing message or other malicious communication message.

As spoofing attacks are prevalently being used, users have used facial recognition computations of a real-time picture of a source in order to validate the user of a received message. However, these facial recognition computations are computationally intensive, and communication delays are imparted in sending and receiving communication messages between users.

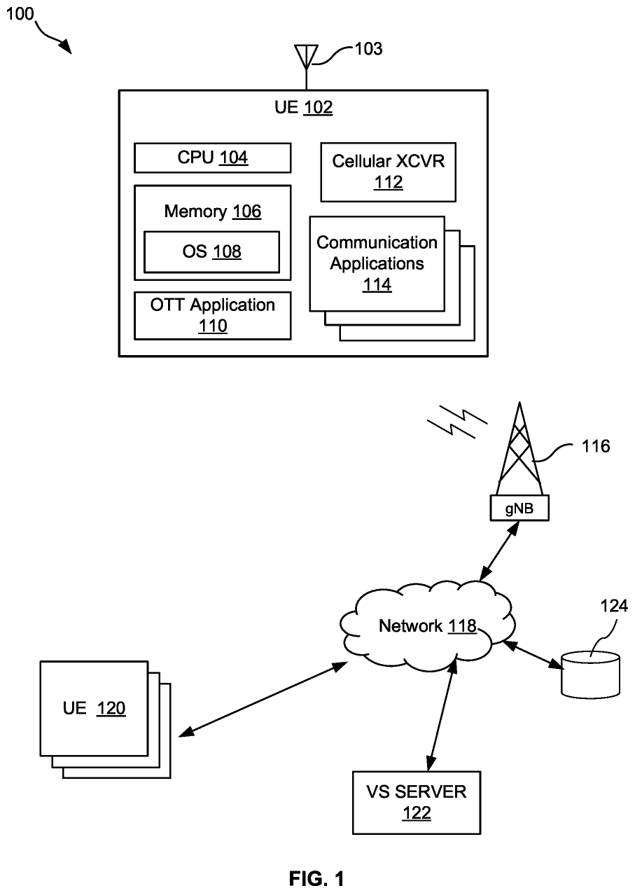

Turning now to FIG. 1, a communication system 100 is described according to an embodiment. In an embodiment, the communication system 100 is configured for verifying an identity of a source (e.g., a sender user) of a communication message that is sent from a source communication device/user equipment (UE) when the communication message is received by a recipient (e.g., receiver user) at a recipient communication device/UE. The user of the UE may be associated with a sender of the communication message to a recipient. In an embodiment, the communication system 100 is configured for verifying the identity based on registering a user for a digital ID verification service using a registration request comprising user information of the user in order to register the user for digital ID verification. In examples, the user may either be the source or the recipient. In an example, the user may transmit, via a communication device, a registration request comprising user information of the user in order to register the user for digital ID verification. While the communication system 100 is described for performing digital ID verification of registered users, the communication system may also be contemplated for use with communications that are received from non-registered users of the digital ID verification service.

In an embodiment, the communication system 100 may comprise user equipment (UE) 102, cell site 116, a communication network 118, UE 120, a verification system (VS) server 122, and storage 124. The UE 102 may be a communication device such as, for example, a smart phone, a wearable computer or another mobile communication device, or an M2M device such as, for example, a smart vehicle, a smart refrigerator, a smart meter, or another similar smart device that has one or more processors, memory, and transceiver components. The UE 102 may be a fixed communication device or a mobile communication device. In embodiments the UE 102 may be associated with a source communication device or a recipient communication device. In an embodiment, the UE 102 comprises an antenna 103, a central processing unit (CPU) 104, a memory 106 that stores an operating system (OS) 108, an over-the-top (OTT) application 110, a cellular transceiver 112, and one or more communication applications 114.

In an embodiment, the antenna 103 may be communicatively coupled to the cellular transceiver 112 and the OTT application 110 through a wired connection. The antenna 103 may include radio frequency (RF) reception and transmission components of the UE 102, and may be part of the cellular transceiver 112. In an embodiment, the cellular transceiver 112 may establish a radio communication link to the cell site 116 using the antenna 103. The radio communication link may be established according to an LTE protocol, a Code Division Multiple Access (CDMA) protocol, a Global System for Mobile Communications (GSM) protocol, or a 5th generation mobile network (5G) telecommunication protocol. In an embodiment, the cellular transceiver 112 includes a 5G RAT that provides an air interface for the UE 102. While not shown in FIG. 1, the cellular radio transceiver 112 may include additional circuit components to process and manipulate the wireless signals at the UE 102.

The memory 106 comprises a non-transitory portion that stores one or more applications for execution by the CPU 104. In embodiments, the memory 106 embeds an operating system (OS) 108, an OTT application 110, and communication applications 114. In an embodiment, the OS 108 comprises executable instructions of an OS kernel of the UE 102 that may be executed by the CPU 104 to perform operations such as, for example, operations to manage input/output data requests to the UE 102 (e.g., from software and/or applications of the OTT application 110 and communication applications 114), translate the requests into instructions (e.g., data processing instructions) for execution by the CPU 104 or other components of the UE 102, manage the UE 102 resources, such as the CPU 104 and the memory 106 when executing and providing services to applications on the UE 102 such as the OTT application 110 and communication applications 114. In an embodiment, communication applications 114 may be third-party applications that are configured to send and receive messages including text, audio, video, and other similar communications from UE 102 (also referred to as a sender UE) to UE 120 (also referred to as receiver UE) using the communication network 118. In examples, communication applications 114 may include software applications to perform specific user-related telecommunication tasks such as, for example, electronic mail (email) applications like OUTLOOK and GMAIL, web conference applications like ZOOM and WEBEX, and social networking applications such as LINKEDIN, FACEBOOK, or other similar applications.

In an embodiment, the OTT application 110 is configured as a utility application or add-on application of communication applications 114 and may be installed at UE 102 after a user of UE 102 registers for a digital ID verification service of the VS server 122. The OTT application 110 is configured to monitor a communication message that is sent to a recipient communication device via the communication application 114, and to send a communication log related to the communication message to a digital ID verification service of the VS server 122. In examples, the digital ID verification service is a cloud-based verification service of a mobile carrier that is configured to verify the authenticity of a source of the communication message when received by the recipient communication device. In an example, the OTT application 110 may be embedded with the communication application 114 and access contents of communication messages that are received by communication applications 114. Further, the OTT application 110 may send a portion of the contents of the communication message and verification requests to a digital ID verification service of the VS server 122 based on receiving the communication message at the communication applications 114. The OTT application 110 comprises executable instructions that when executed by the CPU 104 may actively monitor UE 102 for any communication messages that are received at the UE 102 from UE 120 or the VS server 122. In an example, the UE 102 is registered to monitor communication messages and send authentication requests to the VS server 122 for verifying authenticity of the communication messages that are received.

In an embodiment, the VS server 122 may be configured to register a user for digital ID verification. In examples, the user may be a source or a recipient. In an example, the UE 102 may send a registration request comprising user information of the user to VS server 122 in order to register the user for digital ID verification. In an example, registering the user for digital ID verification enables OTT application 110 to automatically send a verification request to a digital ID verification service of the VS server 122 in order to authenticate a communication message that is received from another user (e.g., communication is from the user and not an attacker), and display indicators at the communication application 114 based on the authenticity determination. In an embodiment, the UE 102 may send user information of the user and digital information that may be applied by a digital ID verification service at the VS server 122 as a digital ID of the user. In embodiments, the digital ID may include digital information in an electronic format such as at least one of an image/photograph, a visual image to represent a user that can be understood and recognized (e.g., a logo), a barcode, a QR code, or other graphical symbol that is intended to represent and identify the user at the VS server 122 when a copy of the digital ID is sent in a communication message from the user (e.g., the source) to another user (e.g., the recipient).

In an embodiment, the VS server 122 may store a hash value of the digital ID as a protected value. The VS server 122 may be configured to verify the authenticity of a source of the communication message at the recipient communication device by comparing the hash value of the digital ID with a new hash value of the copy of the digital ID to determine whether they match. In another example, the VS server 122 may be configured to compare a communication log stored at database 124 with metadata associated with the communication message to identify whether the time stamp in the communication log matches the time stamp in the received communication message.

The UE 102 may be communicatively coupled to the cell site 116. The cell site 116 connects the UE 102 to a communication network 118, UE 120, a VS server 122, and database 124. The communication network 118 may be a core network (for example, a macro network) of a network provider or the Internet Network. In an embodiment, the UE 102 may request 5G services via the cell site 116 of the communication network 118 using the radio communication link. In examples, the communication between the communication network 118 and UE 102 may be established according to an LTE protocol, a CDMA protocol, a GSM protocol, or a 5G telecommunication protocol. The communication network 118 may provide 5G services to the UE 102 using network functions, that include voice, data, and messaging services. The communication network 118 may be communicatively coupled to VS server 122 for providing a digital ID verification service. The VS server 122 may be associated with a mobile carrier of users of UE 102 or UE 120. The system 100 may comprise additional communication networks similar to communication network 118 and any number of cell sites 116.

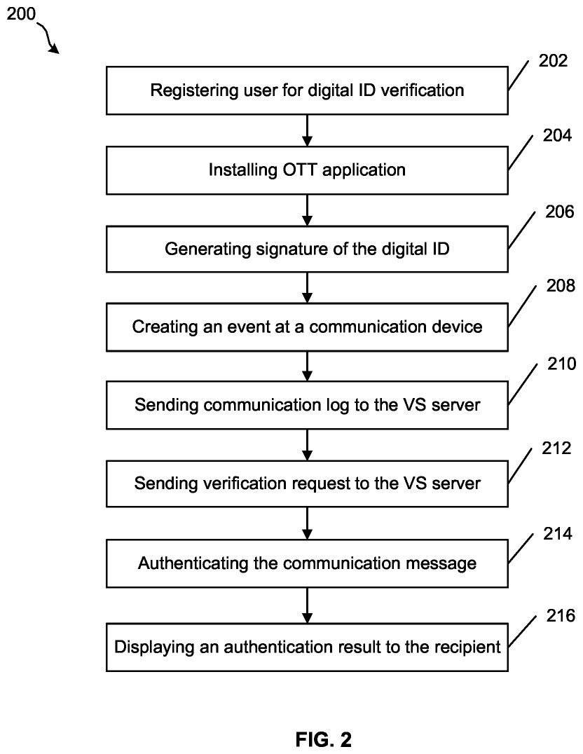

Turning now to FIG. 2, and with continued reference to FIG. 1, a method 200 is described. In an embodiment, the method 200 illustrates a process for verifying a digital ID of a sender user (also referred to as “source”) of a communication message in order to authenticate the true identity of a source of communication messages when the communication message is received at a receiver user (also referred to as “recipient”) communication device. In examples, the communication devices of the source and the recipient may be a consumer device or an M2M device and may be the UE 102 or UE 120 in FIG. 1. In an example, authenticating the source of a communication message includes verifying the source's digital ID by a digital ID verification service at a VS server 122 when an event is initiated at the source's communication device and sent to the recipient's communication device.

At block 202, the method 200 comprises initially registering a user for digital ID verification. In examples, the user may be a source or a recipient. In an example, the user may transmit, via a communication device, a registration request comprising user information of the user to a VS server 122 in order to register the user at the VS server 122 for digital ID verification. In an example, the source or the user may use substantially similar registration information to register with the VS server 122. In an embodiment, the user (e.g., the source or the recipient) of communication network 114 is a subscriber of a mobile carrier, and the mobile carrier may initiate registration by sending a registration link to the user to enable the user to register for a digital ID verification service at the VS server 122. In an example, registering the user for digital ID verification enables a communication application to automatically determine whether a communication message that is received from another user is authentic (e.g., communication is from the user and not an attacker), and display indicators at the communication application based on the authenticity determination. In another example, a user may send registration information to the VS server 122 as a prerequisite for installing a communication application 114 on the communication device of the user.

In an example, the user information may include personal identifiable information of the user and user-defined digital information of the user. In an example, a user profile of the user may be applied as personal identifiable information at VS server 122 and the user-defined digital information may be applied by a digital ID verification service at the VS server 122 as a digital ID of the user (hereinafter “original digital ID”). In an example, the source and the user may obtain individual original digital ID based on user-defined digital information that is sent to the VS server 122. In an example, an original digital ID of the source may be used to authenticate the source when a communication message is sent from the source via the communication application 114 to a recipient. In embodiments, the digital ID may be used with all communication applications 114 on the communication device or with one or more communication applications 114 that are preselected or predetermined by the user. In embodiments, the original digital ID may include digital information in an electronic format such as at least one of an image/photograph, a visual image to represent a user that can be understood and recognized (e.g., a logo), a barcode, a QR code, or other graphical symbol that is intended to represent and identify the user at the VS server 122 when a copy of the original digital ID is used in a communication message from the user (e.g., the source) to another user (e.g., the recipient). In an example, the digital ID verification service may use the user-defined digital information as an original digital ID for identifying the user. In an example, the original digital ID may be stored in database 124.

At block 204, the method 200 comprises installing an OTT application at the communication device. In an example, the VS server 122 may send instructions to a user for downloading and installing an OTT application 110 to the communication device after the initial registration is performed. In another example, the VS server 122 may automatically download and install the OTT application 110 on the communication device after the initial registration is performed. The OTT application 110 may be installed for one or more communication applications 114 on the communication device. In an example, the OTT application may be installed on communication devices of all users (e.g., all source or recipient users) that register for the digital ID verification service.

At block 206, the method 200 comprises generating a signature of the original digital ID. In an example, once the original digital ID is received by the VS server 122, the VS server 122 continues registering the user by hashing the original digital ID using a hash function to generate a signature of the original digital ID. In examples, VS server 122 may select a hash function from one of an average hash function (aHash), gradient hash function (dHash), perceptive hash function (pHash), or wavelet hash function (wHash). In an example, the signature of the original digital ID may be stored in database 124 as a protected hash value.

At block 208, the method 200 comprises creating an event at a communication device. In an example, the source may create an event by sending, to the recipient, a communication message to the recipient such as, for example, by sending an email message, sending an invitation to a web-based video conference, sending an invitation to a web-based phone conference, sending a social media message, or sending a communication message for a similar type of event. In an example, the OTT application may attach a copy of the original digital ID (hereinafter “copy of original digital ID”) to the communication message. In an example, the communication message is transmitted by the communication application 114 to a communication device of the recipient via the communication network 118.

At block 210, the method 200 comprises sending a communication log to the VS server 122. In an example, the OTT application 110 monitors communication/events from the communication application 114 and may send a communication log comprising event information to the VS server 122 in response to the event being sent to the recipient from the communication application 114. The communication log may be encrypted before sending of the communication log to the VS server 122. In an example, the communication log is associated with the particular event between the source and the recipient and may include sender information, receiver information, time stamp of transmitting the communication message, or other similar information. In an example, the communication log may be decrypted prior to storing the decrypted communication log at the database 124 by the VS server 122. The decrypted communication log may be used by the digital ID verification service to authenticate a communication message of the source when the communication message is sent by the source to the recipient.

At block 212, the method 200 comprises sending a verification request to the VS server. In an example, the verification request may request authentication of the source of a communication message. In an example, if the recipient is registered with the VS server 122, the OTT application at a communication device of the recipient (hereinafter “recipient OTT application”) may automatically send a verification request to the VS server 122 for authenticating the source when the communication message from the source is received at the communication application 114 of the recipient and the recipient is registered with the VS server 122. In another example, the recipient OTT application may request verification when the recipient selects the communication message to view the contents of the communication message and the recipient is registered with the VS server 122. In an example, the verification request may include a digital ID that was sent in the communication message and metadata of the received communication message such as, for example, a message header that may include sender, receiver, route, timestamp of sending and receiving, route, or similar metadata information. In an example, the verification request instructs the VS server 122 to verify that the digital ID in the received communication is a copy of the original digital ID and associated with a true identity of the source in the VS server 122 (for example, the communication message is not a spoofing message).

At block 214, the method 200 comprises authenticating the communication message. In an example, the VS server 122 verifies the source of the communication message by authenticating the digital ID using hash values of the digital ID and the protected hash value of the original digital ID. In an example, the digital ID verification service at VS server 122 may hash the digital ID in the verification request to obtain a new hash value. Further, the digital ID verification service may compare the new hash value with the protected hash value of the original digital ID to determine whether they match. In another example, the digital ID verification service compares the communication log with the metadata associated with the communication message to identify whether the time stamp in the communication log matches the time stamp in the received communication message with an adjustment for latency time period for communicating over the communication network 114. In examples, when the hash values match and the time stamps match, the digital ID verification service may determine that the source of the communication message is authentic. However, if the hash values do not match, the digital ID verification service determines that the communication message is a spoofing message and/or the source of the communication message is not the true identity of the source.

At block 216, the method 200 comprises displaying an authentication result to the recipient. In examples, the digital ID verification service sends a verification response to the recipient OTT application that indicates whether the source of the communication message is authentic. In an example, the verification response may include a verification result that includes a result of matching the hash values and/or a result of matching the time stamps. In examples, the recipient OTT application may display results of the verification by overwriting the display ID in the communication message at the recipient communication application 114 with a visual marker that indicates the verification result. In some examples, the visual marker may be a graphical thumbs up with a color indicator or other similar key visual marker with a color indicator to indicate a degree of authenticity of the communication message. In an example, the OTT may display a thumbs up with a green indicator of a corresponding RGB value to indicate the source of the communication message is authentic (e.g., a higher degree of authenticity), a thumbs up with a red indicator of a corresponding RGB value to indicate a spoofed communication message (e.g., a lower degree of authenticity), and a thumbs up with a yellow indicator of a corresponding RGB value to indicate an indeterminate source of the communication message (e.g., degree of authenticity is between the higher degree and the lower degree, or the source may not be registered in the VS service). As the digital ID is overwritten at the recipient communication application 114, an attacker may not be able to avoid detection when the attacker creates a fake digital ID having the visual marker superimposed on the fake digital ID, which improves security in transmitting and receiving communication messages between communication devices over a communication network.

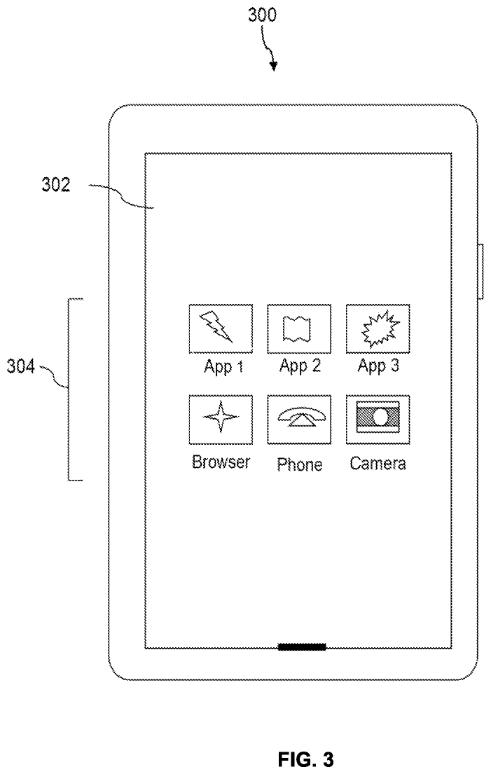

FIG. 3 depicts user equipment (UE) 300, which is operable for implementing aspects of the present disclosure, but the present disclosure should not be limited to these implementations. Though illustrated as a communication device, the UE 300 may take various forms including a smart vehicle, a smart appliance (for example, a smart refrigerator), a smart phone, a wearable computer, a personal digital assistant (PDA), a headset computer, a laptop computer, a notebook computer, and a tablet computer.

The UE 300 includes a touchscreen display 302 having a touch-sensitive surface for input by a user. A small number of application icons 304 are illustrated within the touch screen display 302. It is understood that in different embodiments, any number of application icons 304 may be presented in the touch screen display 302. In some embodiments of the UE 300, a user may be able to download and install additional applications on the UE 300, and an icon associated with such downloaded and installed applications may be added to the touch screen display 302 or to an alternative screen. The UE 300 may have other components such as electro-mechanical switches, speakers, camera lenses, microphones, input and/or output connectors, and other components as are well known in the art. The UE 300 may present options for the user to select, controls for the user to actuate, and/or cursors or other indicators for the user to direct. The UE 300 may further accept data entry from the user, including numbers to dial or various parameter values for configuring the operation of the handset. The UE 300 may further execute one or more software or firmware applications in response to user commands. These applications may configure the UE 300 to perform various customized functions in response to user interaction. Additionally, the UE 300 may be programmed and/or configured over-the-air, for example from a wireless base station, a wireless access point, or a peer UE 300. The UE 300 may execute a web browser application which enables the touch screen display 302 to show a web page. The web page may be obtained via wireless communications with a base transceiver station, a wireless network access node, a peer UE 300 or any other wireless communication network or system.

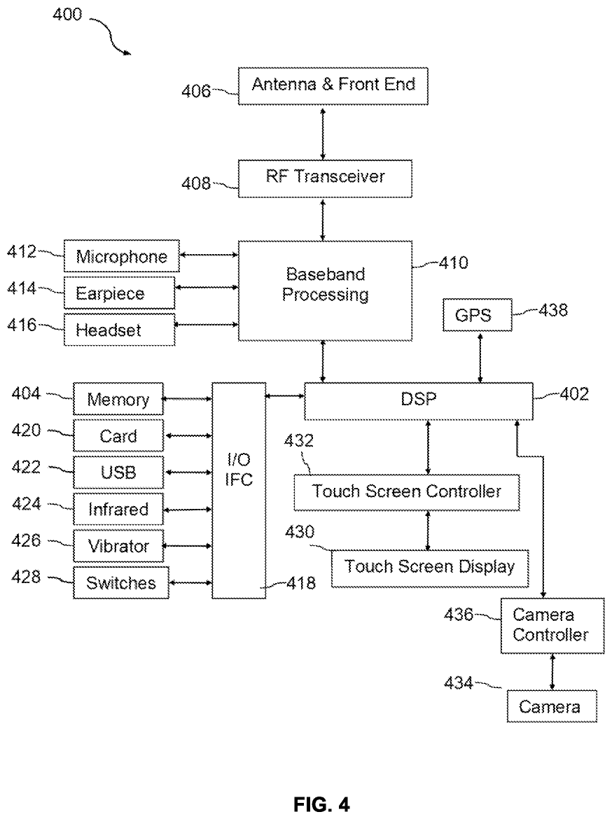

FIG. 4 shows a block diagram of the UE 400. While a variety of known components of a communication device are depicted, in an embodiment a subset of the listed components and/or additional components not listed may be included in the UE 400. The UE 400 includes a digital signal processor (DSP) 402 and a memory 404. As shown, the UE 400 may further include one or more antenna and front end unit 406, a one or more radio frequency (RF) transceiver 408, a baseband processing unit 410, a microphone 412, an earpiece speaker 414, a headset port 416, an input/output (I/O) interface 418, a removable memory card 420, a universal serial bus (USB) port 422, an infrared port 424, a vibrator 426, one or more electro-mechanical switches 428, a touch screen display 430, a touch screen controller 432, a camera 434, a camera controller 436, and a global positioning system (GPS) receiver 438. In an embodiment, the UE 400 may include another kind of display that does not provide a touch sensitive screen. In an embodiment, the UE 400 may include both the touch screen display 430 and additional display component that does not provide a touch sensitive screen. In an embodiment, the DSP 402 may communicate directly with the memory 404 without passing through the input/output interface 418. Additionally, in an embodiment, the UE 400 may comprise other peripheral devices that provide other functionality.

The DSP 402 or some other form of controller or central processing unit operates to control the various components of the UE 400 in accordance with embedded software or firmware stored in memory 404 or stored in memory contained within the DSP 402 itself. In addition to the embedded software or firmware, the DSP 402 may execute other applications stored in the memory 404 or made available via information carrier media such as portable data storage media like the removable memory card 420 or via wired or wireless network communications. The application software may comprise a compiled set of machine-readable instructions that configure the DSP 402 to provide the desired functionality, or the application software may be high-level software instructions to be processed by an interpreter or compiler to indirectly configure the DSP 402.

The DSP 402 may communicate with a wireless network via the analog baseband processing unit 410. In some embodiments, the communication may provide Internet connectivity, enabling a user to gain access to content on the Internet and to send and receive e-mail or text messages. The input/output interface 418 interconnects the DSP 402 and various memories and interfaces. The memory 404 and the removable memory card 420 may provide software and data to configure the operation of the DSP 402. Among the interfaces may be the USB port 422 and the infrared port 424. The USB port 422 may enable the UE 400 to function as a peripheral device to exchange information with a personal computer or other computer system. The infrared port 424 and other optional ports such as a Bluetooth® interface or an IEEE 802.11 compliant wireless interface may enable the UE 400 to communicate wirelessly with other nearby handsets and/or wireless base stations.

In an embodiment, one or more of the radio transceivers is a cellular radio transceiver. A cellular radio transceiver promotes establishing a wireless communication link with a cell site according to one or more of a 5G, an LTE protocol, a CDMA protocol, a GSM protocol. In an embodiment, one of the radio transceivers 408 may comprise a near field communication (NFC) transceiver. The NFC transceiver may be used to complete payment transactions with point-of-sale terminals or other communication exchanges. In an embodiment, each of the different radio transceivers 408 may be coupled to its own separate antenna. In an embodiment, the UE 400 may comprise a radio frequency identify (RFID) reader and/or writer device.

The switches 428 may couple to the DSP 402 via the input/output interface 418 to provide one mechanism for the user to provide input to the UE 400. Alternatively, one or more of the switches 428 may be coupled to a motherboard of the UE 400 and/or to components of the UE 400 via a different path (e.g., not via the input/output interface 418), for example coupled to a power control circuit (power button) of the UE 400. The touch screen display 430 is another input mechanism, which further displays text and/or graphics to the user. The touch screen LCD controller 432 couples the DSP 402 to the touch screen display 430. The GPS receiver 438 is coupled to the DSP 402 to decode global positioning system signals, thereby enabling the UE 400 to determine its position. In an embodiment, the UE 400 is the UE 102 of FIG. 1 that may include a smart high-science appliance such as a smart vehicle, a smart appliance (for example, a smart refrigerator), a smart phone, a wearable computer, a personal digital assistant (PDA), a headset computer, a laptop computer, a notebook computer, and a tablet computer.

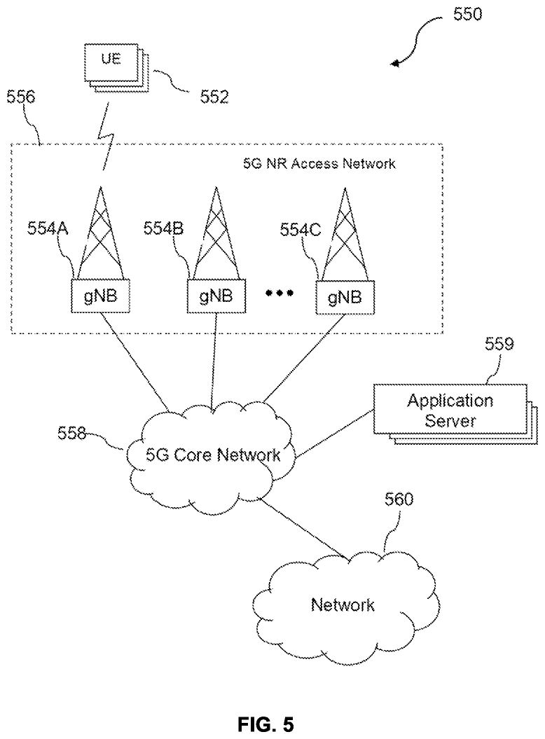

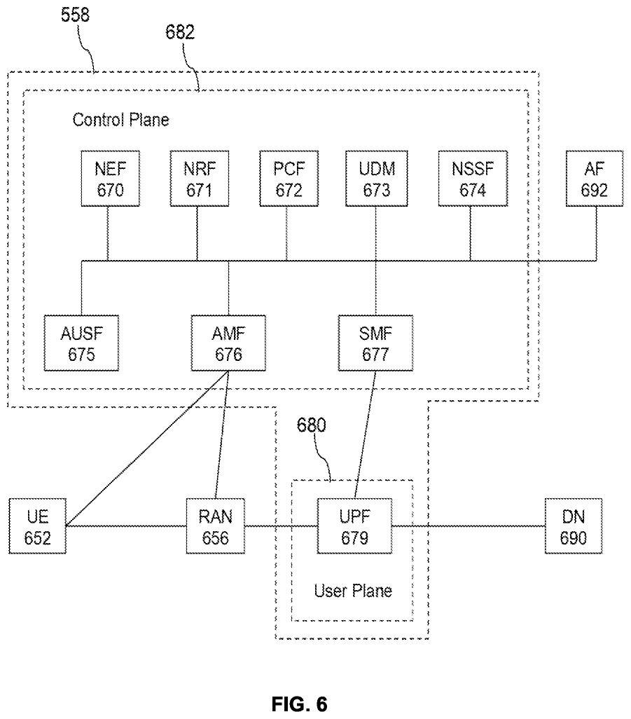

Turning now to FIG. 5, an exemplary communication system 550 is described. Parts of the 5G communication network 118 described above with reference to FIG. 1 may be implemented substantially like the communication system 550 described in FIG. 5 and FIG. 6. Typically, the communication system 550 includes a number of access nodes 554A-554C that are configured to provide coverage in which UEs 552 such as cell phones, tablet computers, machine-type-communication devices, tracking devices, embedded wireless modules, and/or other wirelessly equipped communication devices (whether or not user operated), can operate. The UE 552 may be the UE 102 or the UE 120 that operate with the 5G communication network 118 (FIG. 1). The access nodes 554A-554C may be said to establish an access network 556. The access network 556 may be referred to as a radio access network (RAN) in some contexts. In a 5G technology generation, an access node 554A-554C may be referred to as a gigabit Node B (gNB). In 4G technology (e.g., long term evolution (LTE) technology) an access node 554A-554C may be referred to as an enhanced Node B (eNB). In 3G technology (e.g., code division multiple access (CDMA) and global system for mobile communication (GSM)) an access node 554A-554C may be referred to as a base transceiver station (BTS) combined with a basic station controller (BSC). In some contexts, the access node 554A-554C may be referred to as a cell site or a cell tower. In some implementations, a picocell may provide some of the functionality of an access node 554A-554C, albeit with a constrained coverage area. Each of these different embodiments of an access node 554A-554C may be considered to provide roughly similar functions in the different technology generations.

In an embodiment, the access network 556 comprises a first access node 554A, a second access node 554B, and a third access node 554C. It is understood that the access network 556 may include any number of access nodes 554A-554C. Further, each access node 554A-554C could be coupled with a 5G core network 558 that provides connectivity with various application servers 559 and/or a network 560. In an embodiment, at least some of the application servers 559 may be located close to the network edge (e.g., geographically close to the UE 552 and the end user) to deliver so-called “edge computing.” The network 560 may be one or more private networks, one or more public networks, or a combination thereof. The network 560 may comprise the public switched telephone network (PSTN). The network 560 may comprise the Internet. With this arrangement, a UE 552 within coverage of the access network 556 could engage in air-interface communication with an access node 554A-554C and could thereby communicate via the access node 554A-554C with various application servers and other entities. In another embodiment, the sub-systems may communicate via the access nodes 554A-554C.

The communication system 550 could operate in accordance with a particular RAT, with communications from an access node 554A-554C to UEs 552 defining a downlink or forward link and communications from the UEs 552 to the access node 554A-554C defining an uplink or reverse link. Over the years, the industry has developed various generations of RATs, in a continuous effort to increase available data rate and quality of service for end users. These generations have ranged from “1G,” which used simple analog frequency modulation to facilitate basic voice-call service, to “4G”-such as LTE, which now facilitates mobile broadband service using technologies such as orthogonal frequency division multiplexing (OFDM) and multiple input multiple output (MIMO).

Recently, the industry has been exploring developments in “5G” and particularly “5G NR” (5G New Radio), which may use a scalable OFDM air interface, advanced channel coding, massive MIMO, beamforming, mobile millimeter wave (mmWave) (e.g., frequency bands above 24 GHZ), and/or other features, to support higher data rates and countless applications, such as mission-critical services, enhanced mobile broadband, and massive Internet of Things (IoT). 5G is hoped to provide virtually unlimited bandwidth on demand, for example providing access on demand to as much as 20 gigabits per second (Gbps) downlink data throughput and as much as 10 Gbps uplink data throughput. Due to the increased bandwidth associated with 5G, it is expected that the new networks will serve, in addition to conventional cell phones, general internet service providers for laptops and desktop computers, competing with existing ISPs such as cable internet, and also will make possible new applications in internet of things (IoT) and machine to machine areas.

In accordance with the RAT, each access node 554A-554C could provide service on one or more radio-frequency (RF) carriers, each of which could be frequency division duplex (FDD), with separate frequency channels for downlink and uplink communication, or time division duplex (TDD), with a single frequency channel multiplexed over time between downlink and uplink use. Each such frequency channel could be defined as a specific range of frequency (e.g., in an RF spectrum) having a bandwidth and a center frequency and thus extending from a low-end frequency to a high-end frequency. Further, on the downlink and uplink channels, the coverage of each access node 554 could define an air interface configured in a specific manner to define physical resources for carrying information wirelessly between the access node 554A-554C and UEs 552.

Without limitation, for instance, the air interface could be divided over time into frames, subframes, and symbol time segments, and over frequency into subcarriers that could be modulated to carry data. The example air interface could thus define an array of time-frequency resource elements each being at a respective symbol time segment and subcarrier, and the subcarrier of each resource element could be modulated to carry data. Further, in each subframe or other transmission time interval (TTI), the resource elements on the downlink and uplink could be grouped to define physical resource blocks (PRBs) that the access node could allocate as needed to carry data between the access node and served UEs 552.

In addition, certain resource elements on the example air interface could be reserved for special purposes. For instance, on the downlink, certain resource elements could be reserved to carry synchronization signals that UEs 552 could detect as an indication of the presence of coverage and to establish frame timing, other resource elements could be reserved to carry a reference signal that UEs 552 could measure in order to determine coverage strength, and still other resource elements could be reserved to carry other control signaling such as PRB-scheduling directives and acknowledgement messaging from the access node 554A-554C to served UEs 552. And on the uplink, certain resource elements could be reserved to carry random access signaling from UEs 552 to the access node 554A-554C, and other resource elements could be reserved to carry other control signaling such as PRB-scheduling requests and acknowledgement signaling from UEs 552 to the access node 554A-554C.

The access node 554A-554C, in some instances, may be split functionally into a radio unit (RU), a distributed unit (DU), and a central unit (CU) where each of the RU, DU, and CU have distinctive roles to play in the access network 556. The RU provides radio functions. The DU provides L1 and L2 real-time scheduling functions; and the CU provides higher L2 and L3 non-real time scheduling. This split supports flexibility in deploying the DU and CU. The CU may be hosted in a regional cloud data center. The DU may be co-located with the RU, or the DU may be hosted in an edge cloud data center. The Cu may be hosted in user equipment.

Turning now to FIG. 6, further details of the core network 558 are described. In an embodiment, the core network 558 is a 5G core network. In an embodiment, the core network 558 may be constructed on the communication network 118 (FIG. 1). 5G core network technology is based on a service-based architecture paradigm. Rather than constructing the 5G core network as a series of special purpose communication nodes (e.g., an HSS node, an MME node, etc.) running on dedicated server computers, the 5G core network is provided as a set of services or network functions. These services or network functions can be executed in a private domain environment which supports dynamic scaling and avoidance of long-term capital expenditures (fees for use may substitute for capital expenditures). In an embodiment, these services or network functions may be executed on user equipment such as, for example, executed on the UE 102 of FIG. 1. These network functions can include, for example, a user plane function (UPF) 679, an authentication server function (AUSF) 675, an access and mobility management function (AMF) 676, a session management function (SMF) 677, a network exposure function (NEF) 670, a network repository function (NRF) 671, a policy control function (PCF) 672, a unified data management (UDM) 673, a network slice selection function (NSSF) 674, and other network functions. The network functions may be referred to as virtual network functions (VNFs) in some contexts.

Network functions may be formed by a combination of small pieces of software called microservices. Some microservices can be re-used in composing different network functions, thereby leveraging the utility of such microservices. Network functions may offer services to other network functions by extending application programming interfaces (APIs) to those other network functions that call their services via the APIs. The 5G core network 558 may be segregated into a user plane 680 and a control plane 682, thereby promoting independent scalability, evolution, and flexible deployment.

The UPF 679 delivers packet processing and links the UE 552, via the access node 656, to a data network 690 (e.g., the network 560 illustrated in FIG. 5 or the communication network 118 in FIG. 1). As discussed above, the UE 552 may be the UE 102 that operates with the 5G communication network 118 (FIG. 1). The AMF 676 handles registration and connection management of non-access stratum (NAS) signaling with the UE 552. Said in other words, the AMF 676 manages UE registration and mobility issues. The AMF 676 manages reachability of the UEs 552 as well as various security issues. The SMF 677 handles session management issues. Specifically, the SMF 677 creates, updates, and removes (destroys) protocol data unit (PDU) sessions and manages the session context within the UPF 679. The SMF 677 decouples other control plane functions from user plane functions by performing dynamic host configuration protocol (DHCP) functions and IP address management functions. The AUSF 675 facilitates security processes.

The NEF 670 securely exposes the services and capabilities provided by network functions. The NRF 671 supports service registration by network functions and discovery of network functions by other network functions. The PCF 672 supports policy control decisions and flow-based charging control. The UDM 673 manages network user data and can be paired with a user data repository (UDR) that stores user data such as customer profile information, customer authentication number, and encryption keys for the information. An application function 692, which may be located outside of the core network 558, exposes the application layer for interacting with the core network 558. In an embodiment, the application function 692 may be execute on an application server 559 located geographically proximate to the UE 552 in an “edge computing” deployment mode. The core network 558 can provide a network slice to a subscriber, for example an enterprise customer, that is composed of a plurality of 5G network functions that are configured to provide customized communication service for that subscriber, for example to provide communication service in accordance with communication policies defined by the customer. The NSSF 674 can help the AMF 676 to select the network slice instance (NSI) for use with the UE 552.

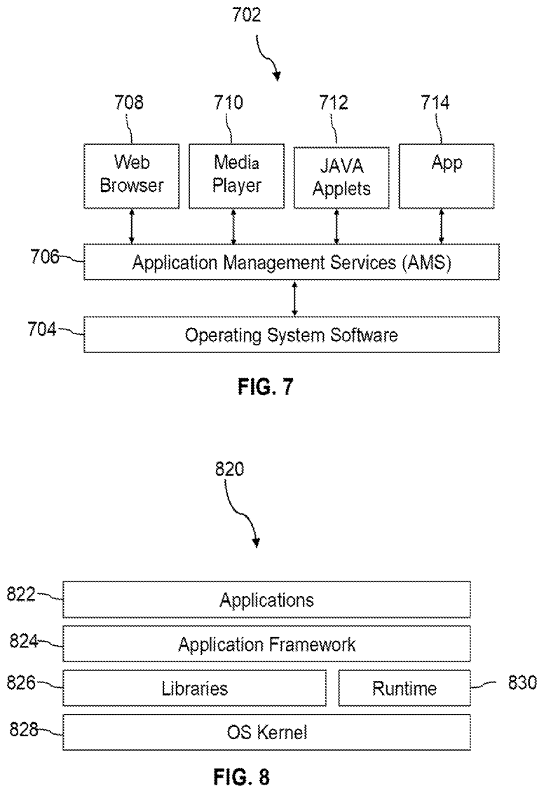

FIG. 7 illustrates a software environment 702 that may be implemented by the DSP 402. The DSP 402 executes operating system software 704 that provides a platform from which the rest of the software operates. The operating system software 704 may provide a variety of drivers for the handset hardware with standardized interfaces that are accessible to application software. The operating system software 704 may be coupled to and interact with application management services (AMS) 706 that transfer control between applications running on the UE 400. Also shown in FIG. 7 are a web browser application 708, a media player application 710, and JAVA applets 712. The web browser application 708 may be executed by the UE 400 to browse content and/or the Internet, for example when the UE 400 is coupled to a network via a wireless link. The web browser application 708 may permit a user to enter information into forms and select links to retrieve and view web pages. The media player application 710 may be executed by the UE 400 to play audio or audiovisual media. The JAVA applets 712 may be executed by the UE 400 to provide a variety of functionality including games, utilities, and other functionality.

FIG. 8 illustrates an alternative software environment 820 that may be implemented by the DSP 402. The DSP 402 executes operating system kernel (OS kernel) 828 and an execution runtime 830. The DSP 402 executes applications 822 that may execute in the execution runtime 830 and may rely upon services provided by the application framework 824. Applications 822 and the application framework 824 may rely upon functionality provided via the libraries 826.

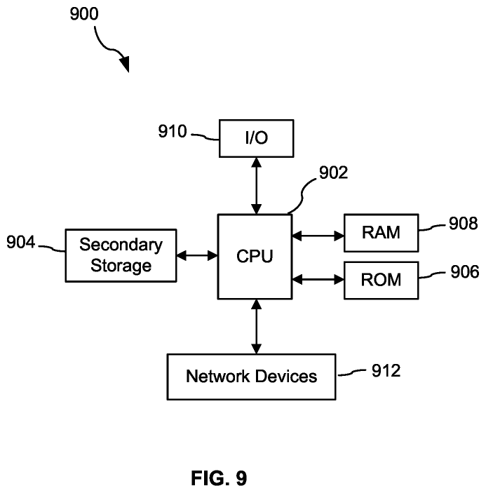

FIG. 9 illustrates a computer system 900 suitable for implementing one or more embodiments disclosed herein. The computer system 900 includes a processor 902 (which may be referred to as a central processor unit (CPU)) that is in communication with memory devices including secondary storage 904, read-only memory (ROM) 906, random-access memory (RAM) 908, input/output (I/O) devices 910, and network connectivity devices 912. The computer system 900 may be UE 102, UE 120, or VS server 122. The processor 902 may be implemented as one or more CPU chips.

It is understood that by programming and/or loading executable instructions onto the computer system 900, at least one of the CPU 902, the RAM 908, and the ROM 906 are changed, transforming the computer system 900 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application-specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 900 is turned on or booted, the CPU 902 may execute a computer program or application. For example, the CPU 902 may execute software or firmware stored in the ROM 906 or stored in the RAM 908. In some cases, on boot and/or when the application is initiated, the CPU 902 may copy the application or portions of the application from the secondary storage 904 to the RAM 908 or to memory space within the CPU 902 itself, and the CPU 902 may then execute instructions that the application is comprised of. In some cases, the CPU 902 may copy the application or portions of the application from memory accessed via the network connectivity devices 912 or via the I/O devices 910 to the RAM 908 or to memory space within the CPU 902, and the CPU 902 may then execute instructions that the application is comprised of. During execution, an application may load instructions into the CPU 902, for example load some of the instructions of the application into a cache of the CPU 902. In some contexts, an application that is executed may be said to configure the CPU 902 to do something, e.g., to configure the CPU 902 to perform the function or functions promoted by the subject application. When the CPU 902 is configured in this way by the application, the CPU 902 becomes a specific purpose computer or a specific purpose machine.

The secondary storage 904 is typically comprised of one or more disk drives or tape drives and is used for non-volatile storage of data and as an over-flow data storage device if RAM 908 is not large enough to hold all working data. Secondary storage 904 may be used to store programs which are loaded into RAM 908 when such programs are selected for execution. The ROM 906 is used to store instructions and perhaps data which are read during program execution. ROM 906 is a non-volatile memory device which typically has a small memory capacity relative to the larger memory capacity of secondary storage 904. The RAM 908 is used to store volatile data and perhaps to store instructions. Access to both ROM 906 and RAM 908 is typically faster than to secondary storage 904. The secondary storage 904, the RAM 908, and/or the ROM 906 may be referred to in some contexts as computer readable storage media and/or non-transitory computer readable media.

I/O devices 910 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 912 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 912 may provide wired communication links and/or wireless communication links (e.g., a first network connectivity device 912 may provide a wired communication link and a second network connectivity device 912 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC) and radio frequency identity (RFID). The radio transceiver cards may promote radio communications using 5G, 5G New Radio, or 5G LTE radio communication protocols. These network connectivity devices 912 may enable the processor 902 to communicate with the Internet or one or more intranets. With such a network connection, it is contemplated that the processor 902 might receive information from the network, or might output information to the network in the course of performing the above-described method steps. Such information, which is often represented as a sequence of instructions to be executed using processor 902, may be received from and outputted to the network, for example, in the form of a computer data signal embodied in a carrier wave.

Such information, which may include data or instructions to be executed using processor 902 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 902 executes instructions, codes, computer programs, scripts which it accesses from hard disk, floppy disk, optical disk (these various disk-based systems may all be considered secondary storage 904), flash drive, ROM 906, RAM 908, or the network connectivity devices 912. While only one processor 902 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 904, for example, hard drives, floppy disks, optical disks, and/or other device, the ROM 906, and/or the RAM 908 may be referred to in some contexts as non-transitory instructions and/or non-transitory information.

In an embodiment, the computer system 900 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 900 to provide the functionality of a number of servers that is not directly bound to the number of computers in the computer system 900. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer-usable program code. The computer program product may be embodied in removable computer storage media and/or non-removable computer storage media. The removable computer readable storage medium may comprise, without limitation, a paper tape, a magnetic tape, magnetic disk, an optical disk, a solid-state memory chip, for example analog magnetic tape, compact disk read only memory (CD-ROM) disks, floppy disks, jump drives, digital cards, multimedia cards, and others. The computer program product may be suitable for loading, by the computer system 900, at least portions of the contents of the computer program product to the secondary storage 904, to the ROM 906, to the RAM 908, and/or to other non-volatile memory and volatile memory of the computer system 900. The processor 902 may process the executable instructions and/or data structures in part by directly accessing the computer program product, for example by reading from a CD-ROM disk inserted into a disk drive peripheral of the computer system 900. Alternatively, the processor 902 may process the executable instructions and/or data structures by remotely accessing the computer program product, for example by downloading the executable instructions and/or data structures from a remote server through the network connectivity devices 912. The computer program product may comprise instructions that promote the loading and/or copying of data, data structures, files, and/or executable instructions to the secondary storage 904, to the ROM 906, to the RAM 908, and/or to other non-volatile memory and volatile memory of the computer system 900.

In some contexts, the secondary storage 904, the ROM 906, and the RAM 908 may be referred to as a non-transitory computer readable medium or a computer readable storage media. A dynamic RAM embodiment of the RAM 908, likewise, may be referred to as a non-transitory computer readable medium in that while the dynamic RAM receives electrical power and is operated in accordance with its design, for example during a period of time during which the computer system 900 is turned on and operational, the dynamic RAM stores information that is written to it. Similarly, the processor 902 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A system, comprising:
a source communication device configured to:
send, to a receiver communication device, a communication message comprising a digital ID of a sending user associated with the source communication device; and
send, to a verification system (VS) server, a communication log corresponding to the communication message and the digital ID;
wherein the receiver communication device is configured to:
receive a second communication message comprising a received digital ID;
send, to the VS server, a verification request responsive to receiving the second communication message, wherein the verification request includes the received digital ID and metadata of the second communication message;
receive, from the VS server, an authentication result responsive to sending the verification request; and
display a visual identifier representing the authentication result; and
wherein the VS server is configured to:
receive, from the receiver communication device, the verification request for instructing the VS server to authenticate the received digital ID and the metadata;
determine an authentication result based on the verification request, wherein the authentication result indicates whether the second communication message is same as the communication message; and
send, to the receiver communication device, the authentication result.

2. The system of claim 1, wherein the VS server is further configured to:
receive, from the source communication device, a registration request comprising first registration information, wherein the first registration information comprises the digital ID;
calculate a hash value of the digital ID; and
store the hash value as a protected hash value.

3. The system of claim 2, wherein the source communication device is further configured to receive, from the VS server, an over-the-top (OTT) application in response to sending the registration request.

4. The system of claim 2, wherein the VS server is further configured to:
calculate a second hash value of the received digital ID;
compare the second hash value with the protected hash value to obtain a comparison result; and
determine the authentication result based on the comparison result.

5. The system of claim 4, wherein the VS server is further configured to compare second metadata in the communication log with the metadata in the second communication message to obtain the comparison result.

6. The system of claim 1, wherein the visual identifier comprises a graphical visual marker with a corresponding color that indicates a degree of authenticity of the communication message.

7. The system of claim 1, wherein the VS server is further configured to receive, from the receiver communication device, second registration information of a receiving user associated with the receiver communication device.

8. The system of claim 1, wherein the digital ID includes at least one of an image, a logo, a barcode, or a graphic symbol.

9. A method for digital picture verification, comprising:
sending, by a source communication device to a receiver communication device, a communication message comprising a digital ID of a sending user associated with the source communication device; and
sending, by the source communication device to a verification system (VS) server, a communication log corresponding to the communication message and the digital ID;
receiving, by the receiver communication device, a second communication message comprising a received digital ID;
sending, by the receiver communication device to the VS server, a verification request responsive to receiving the second communication message, wherein the verification request includes the received digital ID and metadata of the second communication message;
receiving, by the receiver communication device from the VS server, an authentication result responsive to sending the verification request, wherein the authentication result indicates whether the second communication message is same as the communication message; and
displaying, by the receiver communication device, a visual identifier representing the authentication result.

10. The method of claim 9, further comprising:
calculating, by the VS server, a hash value of the digital ID;
storing, by the VS server, the hash value as a protected hash value;
calculating, by the VS server, a second hash value of the received digital ID;
comparing, by the VS server, the second hash value with the protected hash value to obtain a comparison result; and
determining, by the VS server, the authentication result based on the comparison result.

11. The method of claim 9, further comprising comparing, by the VS server, second metadata in the communication log with the metadata in the second communication message to obtain the comparison result.

12. The method of claim 9, wherein the visual identifier comprises a graphical visual marker with a corresponding color that indicates a degree of authenticity of the communication message.

13. The method of claim 9, wherein the VS server is further configured to receive, from the receiver communication device, second registration information of a receiving user associated with the receiver communication device.

14. The method of claim 9, wherein the digital ID and the received digital ID include at least one of an image, a logo, a barcode, or a graphic symbol.

15. A verification system (VS) server, comprising:
a central processing unit (CPU); and
a non-transitory memory comprising executable instructions that when executed by the CPU, causes the VS server to:
receive, from a source communication device, first registration information comprising digital identification (ID) of a sending user, wherein the sending user is associated with the source communication device;
receive, from the source communication device, a communication log corresponding to a first communication message, wherein the communication log comprises first metadata;
receive, from a receiver communication device, a verification request, wherein the verification request includes a second digital ID and second metadata of a second communication message, and wherein the verification request instructs the VS server to authenticate the second communication message; and
send, to the receiver communication device, an authentication result responsive to receiving the verification request, wherein the authentication result indicates whether the second communication message is same as the first communication message, and wherein the authentication result enables the receiver communication device to display a visual identifier representing the authentication result.

16. The VS server of claim 15, wherein the executable instructions further cause the VS server to:
receive, from the source communication device, a registration request comprising the digital ID;
calculate a hash value of the digital ID; and
store the hash value as a protected hash value.

17. The VS server of claim 16, wherein the executable instructions further cause the VS server to:
calculate a second hash value of the second digital ID;
compare the second hash value with the protected hash value to obtain a comparison result; and
determine the authentication result based on the comparison result.

18. The VS server of claim 17, wherein the executable instructions further cause the VS server to compare the first metadata with the second metadata to obtain the comparison result.

19. The VS server of claim 15, wherein the visual identifier comprises a graphical visual marker with a corresponding color that indicates a degree of authenticity of the second communication message.

20. The VS server of claim 15, wherein the digital ID includes at least one of an image, a logo, a barcode, or a graphic symbol.
